(19) United States
(12) Patent Application Publication
(10) Pub. No.: US 2023/0029581 A1
(43) Pub. Date: Feb. 2, 2023

(54) WATER-GLOBE DECORATION LIGHT-AND-SHADOW PEDESTAL STRUCTURE

(71) Applicant: Chin-Sheng Yang, Tainan City (TW)

(72) Inventor: Chin-Sheng Yang, Tainan City (TW)

(21) Appl. No.: 17/387,971

(22) Filed: Jul. 28, 2021

(51) Int. Cl. F21S 10/00; F21V 9/12; F21S 6/00; F21S 10/02

(52) U.S. Cl. CPC F21S 10/002; F21S 6/002; F21S 10/02; F21V 9/12; F21W 2121/00

(57) ABSTRACT

A water-globe decoration light-and-shadow pedestal structure includes a pedestal to which a water-globe decoration is attachable. The pedestal is provided, in an interior thereof, with light-emitting elements. The pedestal has a wall that is formed with at least one hollowed pattern. The water-globe decoration is of a light-transmitting three-dimensional configuration and has a sealed interior space that receives and holds therein a flowable liquid. Height differences of the light-emitting elements relative to the at least one hollowed pattern allows light to pass through the at least one hollowed pattern of the pedestal to project a shadow of the at least one hollowed pattern onto an object outside the pedestal, so as to generate a lighting and shadowing visual effect that is rich and shows variation of layering.

### TECHNICAL FIELD OF THE INVENTION

The present invention relates to a water-globe decoration, and more particularly to a pedestal of a water-globe decoration that is structured to provide an effect of projecting shadows.

### DESCRIPTION OF THE PRIOR ART

In addition to lighting fixtures that are arranged indoors of a household residence for illuminating a large space, lighting decorations are commonly placed in for example living rooms and bedrooms for decoration purposes. Such decorative lightings provide functions of illuminating small, localized areas or for decoration only, as a measure of improving atmosphere of the space through lighting. However, such lighting decorations provide only static exhibition as decoration to be watched. Water-globes that contain tiny ornaments, sequins, and glitter powder in which a visual effect may be achieved through movement of the glitter powder or tiny ornaments with water flows are known. Such water-globes may provide different visual effects by including different forms of contents in the water-globes, so that they provide significant room for further development and availability of remarkable expansion of versatility of visual perceptions, and also, diversification of development in respect of functionality and playfulness thereof. Nevertheless, this is only limited to designs and modifications of the globes themselves, and it would be even more eye-attracting if such globes that provide the functions of decoration and lighting can be used in combination with other parts, such as a pedestal or a seat, which includes different sorts of playfulness or break-throughs in respect of outside appearance for visual perception.

### SUMMARY OF THE INVENTION

In view of the above, the primary objective of the present invention is to provide a light-and-shadow pedestal structure of a water-globe decoration, and the water-globe decoration comprises:

a pedestal, which has a hollowed interior, an electrical control unit being arranged in the interior of the pedestal, the electrical control unit comprising a power supply portion and at least one light-emitting element, the pedestal having a wall that is formed with at least one light-transmitting hollowed pattern.

The pedestal is attachable to a water-globe decoration, which is of a light-transmitting three-dimensional configuration having a sealed interior space receiving and holding therein a flowable liquid.

As such, a height difference of the at least one light-emitting element relative to the at least one hollowed pattern allows a shadow of the hollowed pattern to be projected onto an object outside the pedestal, so as to achieve an effect of projection varying for the shadow projected outside the pedestal.

### BRIEF DESCRIPTION OF THE DRAWINGS

FIG. 1 is a perspective view showing the present invention.

FIG. 2 is an exploded view showing the present invention.

FIG. 3 is a cross-sectional view of the present invention, illustrating a condition of projecting shadows.

FIG. 4 is a perspective view showing a second illustrative example of the present invention.

FIG. 5 is a cross-sectional view of the second illustrative example of the present invention, illustrating a condition of projecting shadows.

FIG. 6 is a perspective view showing a third illustrative example of the present invention.

FIG. 7 is an exploded view showing the third illustrative example of the present invention.

FIG. 8 is a perspective view showing a first illustrative example of the present invention.

FIG. 9 is an exploded view showing the first illustrative example of the present invention.

FIG. 10 is a cross-sectional view of the first illustrative example of the present invention, illustrating a condition of projecting shadows.

### DETAILED DESCRIPTION OF THE PREFERRED EMBODIMENT

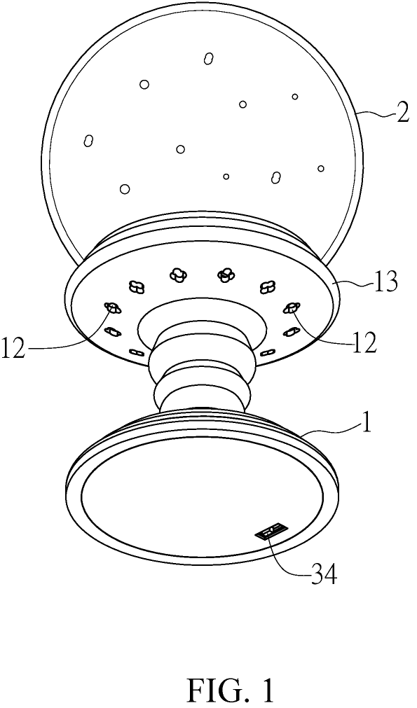

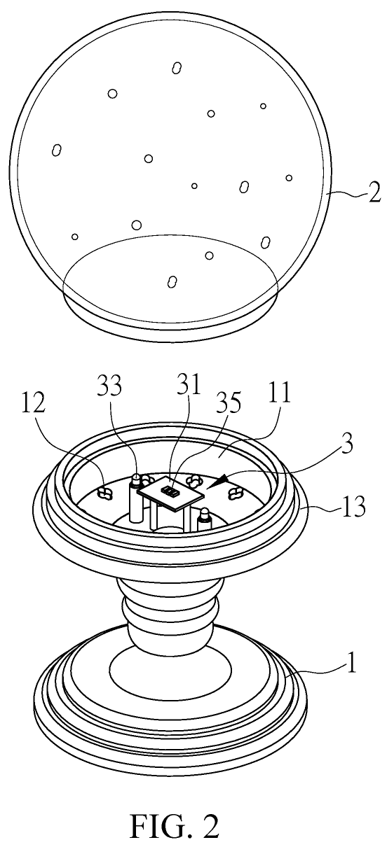

Referring to FIGS. 1-3, a preferred embodiment of the present invention provides a water-globe, which includes: a pedestal or seat (1) and a water-globe decoration (2), and the water-globe decoration (2) is mounted to a top of the pedestal (1).

The pedestal (1) is of a hollowed structure having a hollow interior and comprises an opening (11). The pedestal (1) is provided, in the interior thereof, with an electrical control unit (3). The electrical control unit (3) comprises a circuit board (31), a power supply portion (32), a plurality of light-emitting elements (33), and a switch (34). The power supply portion (32), the light-emitting elements (33), and the switch (34) are in electrical connection with the circuit board (31). The switch (34) is in contact with an electrical power source so as to generate electrical power. The present invention does not limit the form of the electrical power source, which may be an electric main or a battery.

Further, the pedestal (1) is of light opaqueness and has a wall in which at least one light transmitting hollowed pattern (12) is formed. The hollowed pattern (12) may include custom-made characters or figures. In the instant embodiment, the pedestal (1) is provided, on the top thereof, with a platform (13) that receives and bears the water-globe decoration (2) thereon, wherein the platform (13) is formed with multiple ones of such hollowed pattern (12) that are spaced from each other and each of the hollowed patterns (12) is in the form of a penetrating hole, and each of the light-emitting elements (33) is arranged between a bottom of the water-globe decoration (2) and a respective one of the hollowed patterns (12), so that light (L) emitting from each of the light-emitting elements (33) may transmit upward to light the water-globe decoration (2) and also transmits downward to pass through the respective one of the hollowed patterns (12) for outward projection.

The water-globe decoration (2) can be of a light-transmitting three-dimensional configuration mounted to the opening (11) of the platform (13). The water-globe decoration (2) comprises a casing (21) and a bottom lid (22). The casing (21) has a bottom that is formed as an open end and the bottom lid (22) is mounted to the bottom of the casing (21) to close and seal the open end. The water-globe decoration (2) has a sealed interior space in which a thick, flowable liquid is received. To enhance the effect of decoration for the water-globe decoration (2), the liquid may be added with glitter powder or sequins, so that when the liquid flows, various visually perceivable changes may be provided to consumers.

In the instant embodiment, the interior of the water-globe decoration (2) is filled with a liquid having a low boiling point. Preferably, the liquid is a mixture of water and calcium nitrate mixed at a proper ratio. The electrical control unit (3) comprises a plurality of electrical heating members (35), and each of the electrical heating members (35) is electrically connected with the circuit board (31). Each of the electrical heating members (35) may include one of an electrical heating filament, an electrical heating plate, a cement resistor, and an incandescent light bulb and is arranged to correspond to and face the bottom of the water-globe decoration (2), such that when electrical power is supplied to each of the electrical heating members (35), the electrical heating member (35) generates heat that drives the liquid contained in the water-globe decoration (2) to flow.

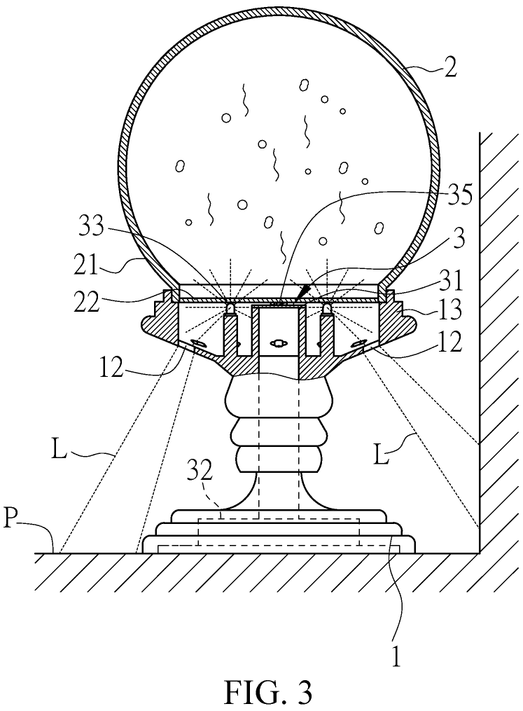

Further referring to FIG. 3, under the condition that the power supply portion (32) is in operation to supply or transmit electricity, the light (L) emitting from each of the light-emitting elements (33) passes through and projects out of the respective one of the hollowed patterns (12) so as to project a shadow, or cast a projection, of the hollowed pattern (12) onto an object (P). In the drawings of the instant embodiment, an example that the projection is made onto a tabletop and a wall is provide for illustrating, but not limiting, the present invention. By setting different height differences of the light-emitting elements (33) relative to the hollowed patterns (12), lighting shadows that are projected to the outside of the pedestal (1) may be varying.

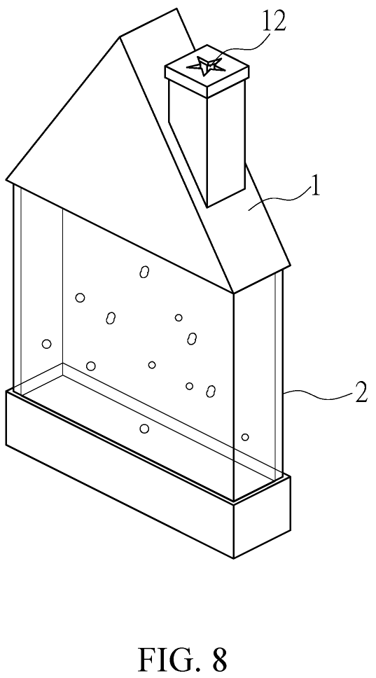

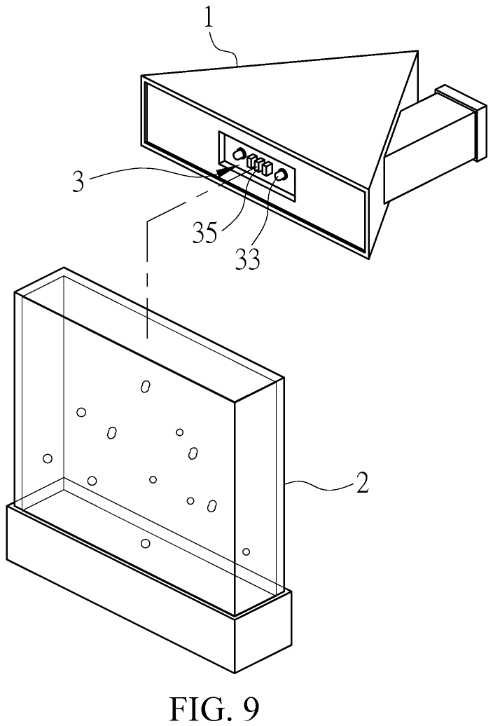

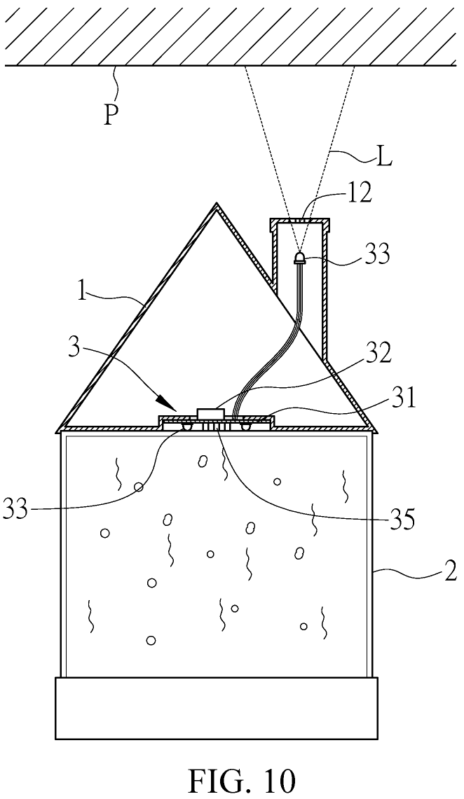

Further referring to FIGS. 8-10, a first illustrative example is provided as a modification of the above-described structure of the present invention, and consequently, portions of the structure that are not modified will not be described repeatedly. In the instant example, the water-globe decoration (2) is positioned on a flat fixture surface, while the pedestal or seat (1) is mounted on a top of the water-globe decoration (2). The electrical control unit (3) is arranged on a bottom of the pedestal or seat (1) and faces toward the water-globe decoration (2). The electrical control unit (3) comprises the plurality of light-emitting elements (33), and each of the light-emitting elements (33) projects light toward and thus illuminates the water-globe decoration (2) and also the hollowed pattern (12), such that the light (L) from the light-emitting elements (33) passes through the hollowed pattern (12) to project a shadow, or cast a projection, of the hollowed pattern (12) on to an object (P).

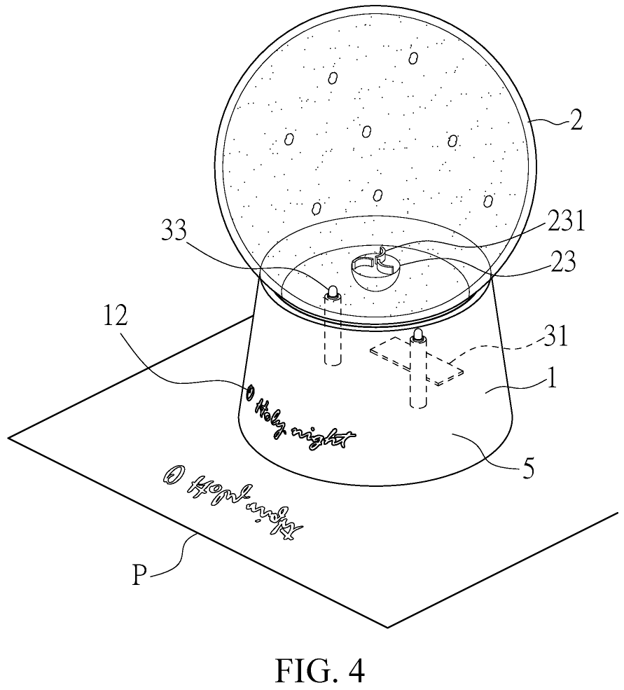

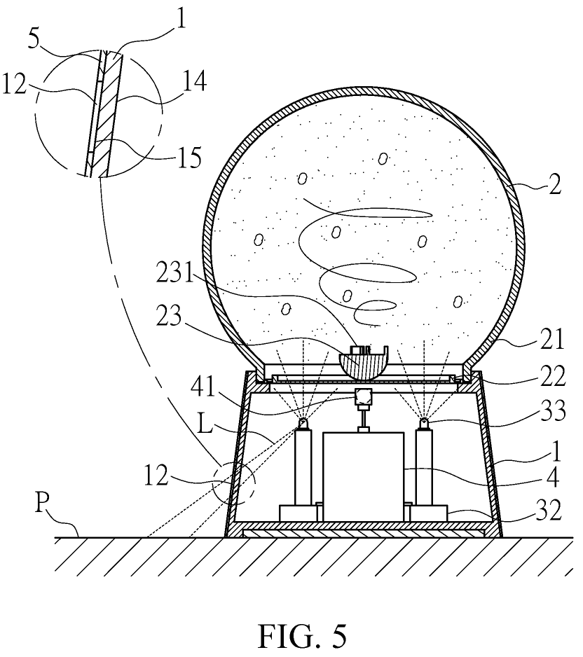

Referring to FIGS. 4 and 5, a second illustrative example is provided as a modification of the above-described structure of the present invention. In the instant example, the pedestal (1) is provided, in the interior thereof, with a motor (4) that has a magnetic spindle (41), and the motor (4) is in electrical connection with the circuit board (31). The water-globe decoration (2) is provided, in the interior thereof, with a magnetic rotating piece (23). The rotating piece (23) has a lower part that is of a semispherical form and an upper part that is provided with a plurality of driving tabs (231). The driving tabs (231) are arranged in a mutually spaced, radiating form. The rotating piece (23) is magnetically attracted by the magnetic spindle (41) so as to be rotatable in unison therewith to disturb the liquid and, if any, the sequins or the glitter powder, to generate an effect of flowing.

Further, in the instant embodiment, the pedestal (1) may alternatively be light transmitting and has an inside surface (14) or an outside surface (15) that is covered with a decorative layer (5). In the illustration of the drawings of the instant example, illustration as an example is made for the decorative layer attached to and covering the outside surface (15) of the pedestal (1). The decorative layer (5) can be formed through coating of a paint or colorant or made by means of electroplating. The hollowed patterns (12) are formed in the decorative layer (5) by means of dedicated art, such as laser engraving being applied to engrave the decorative layer (5) to form hollows, as illustrated in the enlarged view provided in FIG. 5. The hollowed patterns (12) so formed allow light (L) from each of the light-emitting elements (33) to project therethrough to reach the outside and thus casting a projection, or projecting a shadow, onto the object (P) that is located outside the pedestal (1). Further, the circuit board (31) controls variation of color of each of the light-emitting elements (33) to achieve an effect of varying shadows.

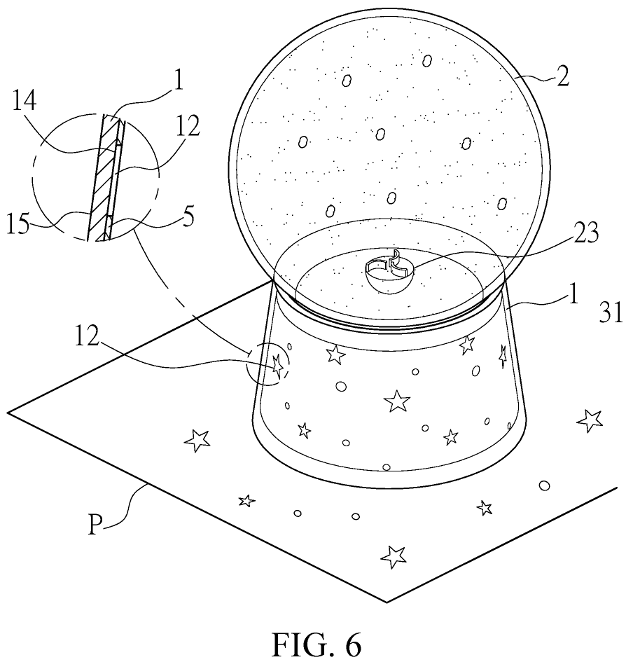

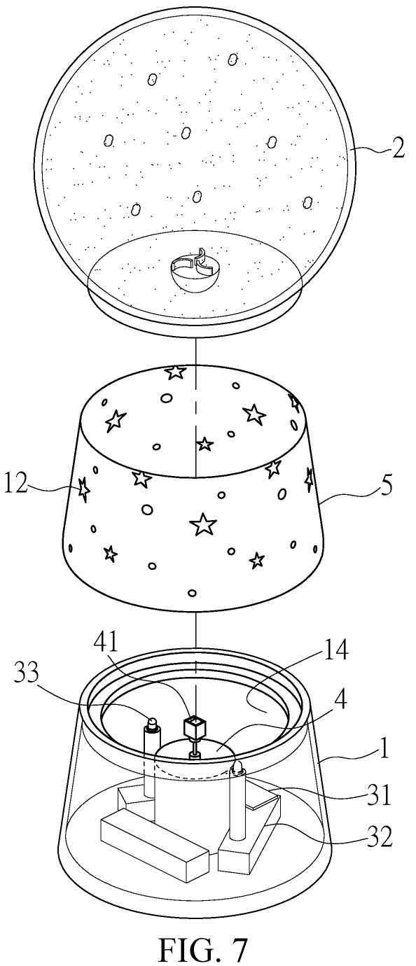

Further referring to FIGS. 6 and 7, a third illustrative example is provided as a modification of the above-described structure of the present invention. In the instant example, the pedestal (1) comprises a light transmitting or transparent housing having an inside surface (14) that is provided, circumferentially, with a decorative layer (5) arranged thereon. The decorative layer (5) is a flexible or bendable sheet or plate, such as a paper sheet or a plastic sheet, and the hollowed patterns (12) are formed in the decorative layer (5).

Following the above, the decorative layer (5) comprises an un-light-transmittable plate or sheet, which, as shown in an enlarged view provided in FIG. 6, is circumferentially arranged on the inside surface (14) of the pedestal (1). The decorative layer (5) has a surface that includes one or more colors. The hollowed patterns (12) are penetrating holes or hollows formed by means of laser engraving, such that desired patterns are formed by removing corresponding parts of the un-light-transmittable plate or sheet to make the parts of the un-light-transmittable plate or sheet hollowed and thus light transmittable relative to the remaining part of the un-light-transmittable plate or sheet.

As such, light (L) emitting from each of the light-emitting elements (33) may pass through the hollowed patterns (12) to project to the outside and thus casting a projection, or projecting a shadow, of each of the hollowed patterns (12) onto an outside object (P), so that the pedestal (1) according to the present invention so structure provides an effect of varying the projections or varying the projected shadows.

1. A water-globe decoration pedestal structure, comprising:
a pedestal, which has a hollowed interior, an electrical control unit being arranged in the interior of the pedestal, the electrical control unit comprising a power supply portion and at least one light-emitting element, the pedestal having a wall that is formed with at least one light-transmitting hollowed pattern,
wherein the pedestal is attachable to a water-globe decoration, which is of a light-transmitting three-dimensional configuration having a sealed interior space receiving and holding therein a flowable liquid; and
a height difference of the at least one light-emitting element relative to the at least one hollowed pattern allows a shadow of the hollowed patten1 to be projected onto an object outside the pedestal;
wherein the pedestal is light transmitting and has an inside surface and an outside surface of which one is covered by a decorative layer, the at least one hollowed pattern being formed in the decorative layer.

2. The water-globe decoration pedestal structure according to claim 1, wherein the at least one hollowed pattern comprises a penetrating hole.

3. (canceled)

4. The water-globe decoration pedestal structure according to claim 1, wherein the decorative layer is a flexible sheet.

5. The water-globe decoration pedestal structure according to claim 1, wherein the electrical control unit further comprises a circuit board and a switch, wherein the power supply portion, the at least one light-emitting element, and the switch are in electrical connection with the circuit board, the switch being in contact with an electrical power source to generate electrical power.

6. (canceled)

7. (canceled)

8. The water-globe decoration pedestal structure according to claim 1, wherein the pedestal is provided, in the interior thereof, with a motor having a magnetic spindle, the motor being in electrical connection with the circuit board, and the water-globe decoration is provided, in an interior thereof, with a magnetic rotating piece, the rotating piece being magnetically attracted by the magnetic spindle to be rotatable in unison therewith.

9. The water-globe decoration pedestal structure according to claim 8, wherein the rotating piece has an upper part that comprises a plurality of driving tabs, the driving tabs being arranged in a mutually spaced, radiating form.
